(19) United States
(12) Patent Application Publication
(10) Pub. No.: US 2007/0110178 A1
(43) Pub. Date: May 17, 2007

(54) Configurable de-interleaver design

(75) Inventors: Ling Su, Cupertino, CA (US); Joachim S. Hammerschmidt, Mountain View, CA (US)

Correspondence Address: GARLICK HARRISON & MARKISON, P.O. BOX 160727, AUSTIN, TX, 78716-0727, US

(73) Assignee: Broadcom Corporation, a California Corporation, Irvine, CA (US)

(21) Appl. No.: 11/595,618

(22) Filed: Nov. 11, 2006

Related U.S. Application Data
(60) Provisional application No. 60/735,501, filed on Nov. 11, 2005.

(51) Int. Cl. H04K 1/10

(52) U.S. Cl. 375/260

(57) ABSTRACT

An integrated circuit radio transceiver and method therefor is operable to flexibly and efficiently de-interleave a received communication signal by initially changing a received signal from the time domain to the frequency domain to generate a plurality of tones that are then rearranged in a first de-interleaving step to an order expected by a downstream decoder. Thereafter, the tones are detected to generate a soft bit sequence and are then reverse-swizzled and de-interleaved. The de-interleaving step is performed in a manner that compensates for row/column offset interleaving performed by a transmitter that transmitted the received signal being processed.

### CROSS REFERENCE TO RELATED APPLICATIONS

This application claims priority to and the benefit of U.S. Provisional Application under 35 U.S.C. 119(e) having a serial number of 60/735,501 and a filing date of Nov. 11, 2005, which is incorporated herein by reference for all purposes. This application also is related to and incorporates by reference the co-pending application having Attorney Docket Number BP5135, a serial number of ______ and a title of “Configurable De-Interleaver Design” by the same inventors as the present application.

### BACKGROUND

1. Technical Field

The present invention relates to wireless communications and, more particularly, to circuitry for generating outgoing communication signals.

2. Related Art

Communication systems are known to support wireless and wire lined communications between wireless and/or wire lined communication devices. Such communication systems range from national and/or international cellular telephone systems to the Internet to point-to-point in-home wireless networks. Each type of communication system is constructed, and hence operates, in accordance with one or more communication standards. For instance, wireless communication systems may operate in accordance with one or more standards, including, but not limited to, IEEE 802.11, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), and/or variations thereof.

Depending on the type of wireless communication system, a wireless communication device, such as a cellular telephone, two-way radio, personal digital assistant (PDA), personal computer (PC), laptop computer, home entertainment equipment, etc., communicates directly or indirectly with other wireless communication devices. For direct communications (also known as point-to-point communications), the participating wireless communication devices tune their receivers and transmitters to the same channel or channels (e.g., one of a plurality of radio frequency (RF) carriers of the wireless communication system) and communicate over that channel(s). For indirect wireless communications, each wireless communication device communicates directly with an associated base station (e.g., for cellular services) and/or an associated access point (e.g., for an in-home or in-building wireless network) via an assigned channel. To complete a communication connection between the wireless communication devices, the associated base stations and/or associated access points communicate with each other directly, via a system controller, via a public switch telephone network (PSTN), via the Internet, and/or via some other wide area network.

Each wireless communication device includes a built-in radio transceiver (i.e., receiver and transmitter) or is coupled to an associated radio transceiver (e.g., a station for in-home and/or in-building wireless communication networks, RF modem, etc.). As is known, the transmitter includes a data modulation stage, one or more intermediate frequency stages, and a power amplifier stage. The data modulation stage converts raw data into baseband signals in accordance with the particular wireless communication standard. The one or more intermediate frequency stages mix the baseband signals with one or more local oscillations to produce RF signals. The power amplifier stage amplifies the RF signals prior to transmission via an antenna.

The data modulation stage is often implemented on a baseband processor or signal processing chip, while frequency conversion stages and power amplifier stages are implemented on a separate radio processor chip. Historically, radio integrated circuits have been designed using bi-polar circuitry, allowing for large signal swings and linear transmitter component behavior. Therefore, many legacy baseband processors employ analog interfaces that communicate analog signals to and from the radio processor.

One common technique for enhancing communications is to modify an order of related bits (interleave the bits) that collectively define a value or term to minimize effects of interference. For example, permutation of the order of bits in a given bit stream may result in consecutive bits lost to interference being from a plurality of data packets such that only one bit or very few bits are lost from a single data packet. By interleaving bits to distribute lost bits within a data packet, the likelihood that error detection/correction techniques are able reconstruct the represented values or terms is enhanced.

To provide a simple illustration of interleaving, five bits received with the following values 01101 may be interleaved and transmitted as 11010. Thus, the order of bits received (1-5) are transmitted in the order of 3, 5, 1, 2, 4. While merely changing the order of five bits may not provide notable advantage, interleaving can be advantageous when bits of a data packet are spread out in relation to each other. It should be understood that a substantially greater number of bits (i.e., the bits of a four micro-second frame) are interleaved in this manner. Five bits are used herein merely to provide a simple example.

Along these lines, interleaving may desirably be applied to MIMO type communication devices in which a plurality of outgoing signal paths carry a plurality of outgoing data streams. While there exists a need for specific implementations for multi-branch interleaving, there is a further need for developing interleaving methodologies that are configurable and flexible. Moreover, there further exits a need for compatible de-interleaving methods and devices that not only de-interleave a signal interleaved according to various embodiments of the interleaver invention, but that also perform such de-interleaving in a hardware efficient approach that satisfies performance requirements.

### SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

A better understanding of the present invention can be obtained when the following detailed description of the preferred embodiment is considered with the following drawings, in which:

FIG. 1 is a functional block diagram illustrating a communication system that includes circuit devices and network elements and operation thereof according to one embodiment of the invention.

FIG. 2 is a schematic block diagram illustrating a wireless communication host device and an associated radio;

FIG. 3 is a schematic block diagram illustrating a wireless communication device that includes a host device and an associated radio;

FIG. 4 is a functional block diagram of a wireless orthogonal frequency division multiplex (OFDM) transmitter processor that includes a multi-stream bit interleaver according to one embodiment of the invention;

FIG. 5 is a functional block diagram of a configurable stream parser and frequency interleaver according to an embodiment of the invention;

FIG. 6 is a table that illustrates a method for interleaving according to one embodiment of the invention;

FIG. 7 is a functional block diagram that illustrates an interleaver system 200 and control logic therefor according to one embodiment of the present invention;

FIGS. 8 and 9 are exemplary interleaving configuration tables that illustrate two methods according to various embodiments of the present invention for performing row/column offset interleaving for a single or an OFDM transmission scheme;

FIG. 10 is a functional block diagram of an interleaver control system according to one embodiment of the invention;

FIGS. 11 and 12 are flow charts that illustrate a interleaving according to embodiments of the invention;

FIG. 13 is a flow chart that illustrates a method for interleaving according to one embodiment of the invention;

FIG. 14 is a functional block diagram of a wireless transceiver processor according to one embodiment of the invention;

FIG. 15 is a flow chart illustrating a method for tone and block de-interleaving according to one embodiment of the invention; and

FIG. 16 is a flow chart that illustrates a two-step method for de-interleaving a received signal according to one embodiment of the invention.

### DETAILED DESCRIPTION OF THE DRAWINGS

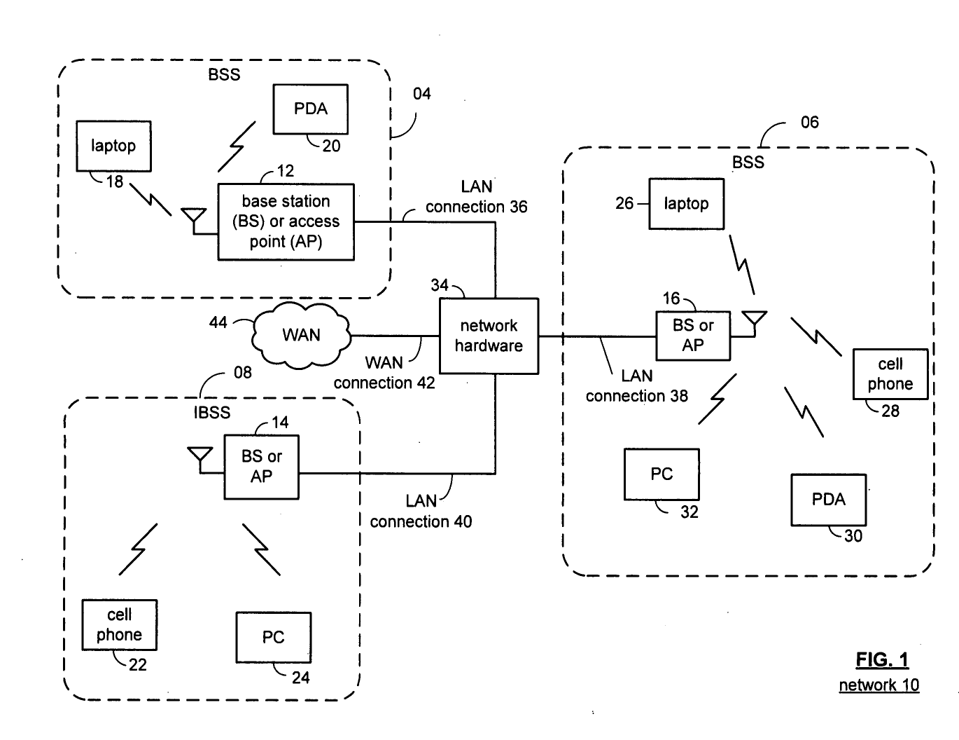

FIG. 1 is a functional block diagram illustrating a communication system that includes circuit devices and network elements and operation thereof according to one embodiment of the invention. More specifically, a plurality of network service areas 04, 06 and 08 are a part of a network 10. Network 10 includes a plurality of base stations or access points (APs) 12-16, a plurality of wireless communication devices 18-32 and a network hardware component 34. The wireless communication devices 18-32 may be laptop computers 18 and 26, personal digital assistants 20 and 30, personal computers 24 and 32 and/or cellular telephones 22 and 28. The details of the wireless communication devices will be described in greater detail with reference to Figures that follow.

The base stations or APs 12-16 are operably coupled to the network hardware component 34 via local area network (LAN) connections 36, 38 and 40. The network hardware component 34, which may be a router, switch, bridge, modem, system controller, etc., provides a wide area network (WAN) connection 42 for the communication system 10 to an external network element such as WAN 44. Each of the base stations or access points 12-16 has an associated antenna or antenna array to communicate with the wireless communication devices in its area. Typically, the wireless communication devices 18-32 register with the particular base station or access points 12-16 to receive services from the communication system 10. For direct connections (i.e., point-to-point communications), wireless communication devices communicate directly via an allocated channel.

Typically, base stations are used for cellular telephone systems and like-type systems, while access points are used for in-home or in-building wireless networks. Regardless of the particular type of communication system, each wireless communication device includes a built-in radio and/or is coupled to a radio. Generally, though, each transmitter is operable to interleave outgoing signals and to de-interleave ingoing signals according to the various embodiments of the invention.

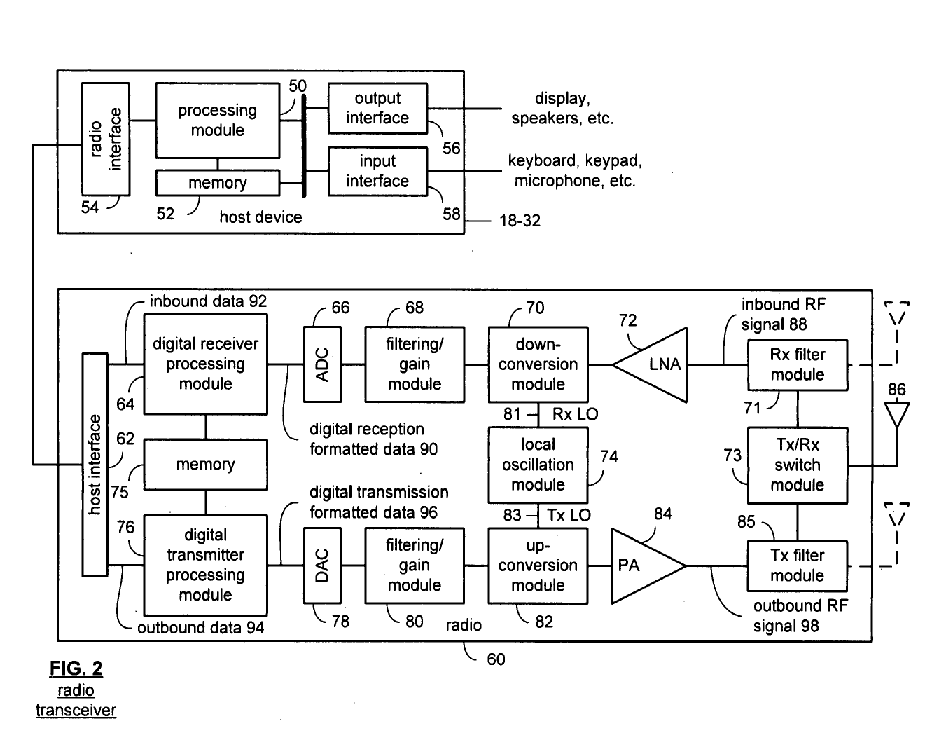

FIG. 2 is a schematic block diagram illustrating a wireless communication host device 18-32 and an associated radio 60. For cellular telephone hosts, radio 60 is a built-in component. For personal digital assistants hosts, laptop hosts, and/or personal computer hosts, the radio 60 may be built-in or an externally coupled component.

As illustrated, wireless communication host device 18-32 includes a processing module 50, a memory 52, a radio interface 54, an input interface 58 and an output interface 56. Processing module 50 and memory 52 execute the corresponding instructions that are typically done by the host device. For example, for a cellular telephone host device, processing module 50 performs the corresponding communication functions in accordance with a particular cellular telephone standard.

Radio interface 54 allows data to be received from and sent to radio 60. For data received from radio 60 (e.g., inbound data), radio interface 54 provides the data to processing module 50 for further processing and/or routing to output interface 56. Output interface 56 provides connectivity to an output device such as a display, monitor, speakers, etc., such that the received data may be displayed. Radio interface 54 also provides data from processing module 50 to radio 60. Processing module 50 may receive the outbound data from an input device such as a keyboard, keypad, microphone, etc., via input interface 58 or generate the data itself. For data received via input interface 58, processing module 50 may perform a corresponding host function on the data and/or route it to radio 60 via radio interface 54.

Radio 60 includes a host interface 62, a digital receiver processing module 64, an analog-to-digital converter 66, a filtering/gain module 68, a down-conversion module 70, a low noise amplifier 72, a receiver filter module 71, a transmitter/receiver (Tx/Rx) switch module 73, a local oscillation module 74, a memory 75, a digital transmitter processing module 76, a digital-to-analog converter 78, a filtering/gain module 80, an up-conversion module 82, a power amplifier 84, a transmitter filter module 85, and an antenna 86 operatively coupled as shown. The antenna 86 is shared by the transmit and receive paths as regulated by the Tx/Rx switch module 73. The antenna implementation will depend on the particular standard to which the wireless communication device is compliant.

Digital receiver processing module 64 and digital transmitter processing module 76, in combination with operational instructions stored in memory 75, execute digital receiver functions and digital transmitter functions, respectively. The digital receiver functions include, but are not limited to, demodulation, constellation demapping, decoding, and/or descrambling. The digital transmitter functions include, but are not limited to, scrambling, encoding, constellation mapping, and modulation. Digital receiver and transmitter processing modules 64 and 76, respectively, may be implemented using a shared processing device, individual processing devices, or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions.

Memory 75 may be a single memory device or a plurality of memory devices. Such a memory device may be a read-only memory, random access memory, volatile memory, non-volatile memory, static memory, dynamic memory, flash memory, and/or any device that stores digital information. Note that when digital receiver processing module 64 and/or digital transmitter processing module 76 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry. Memory 75 stores, and digital receiver processing module 64 and/or digital transmitter processing module 76 executes, operational instructions corresponding to at least some of the functions illustrated herein.

In operation, radio 60 receives outbound data 94 from wireless communication host device 18-32 via host interface 62. Host interface 62 routes outbound data 94 to digital transmitter processing module 76, which processes outbound data 94 in accordance with a particular wireless communication standard or protocol (e.g., IEEE 802.11(a), IEEE 802.9, Bluetooth, etc.) to produce digital transmission formatted data 96. Digital transmission formatted data 96 will be a digital baseband signal or a digital low IF signal, where the low IF typically will be in the frequency range of one hundred kilohertz to a few megahertz.

Digital-to-analog converter 78 converts digital transmission formatted data 96 from the digital domain to the analog domain. Filtering/gain module 80 filters and/or adjusts the gain of the analog baseband signal prior to providing it to up-conversion module 82. Up-conversion module 82 directly converts the analog baseband signal, or low IF signal, into an RF signal based on a transmitter local oscillation 83 provided by local oscillation module 74. Power amplifier 84 amplifies the RF signal to produce an outbound RF signal 98, which is filtered by transmitter filter module 85. The antenna 86 transmits outbound RF signal 98 to a targeted device such as a base station, an access point and/or another wireless communication device.

Radio 60 also receives an inbound RF signal 88 via antenna 86, which was transmitted by a base station, an access point, or another wireless communication device. The antenna 86 provides inbound RF signal 88 to receiver filter module 71 via Tx/Rx switch module 73, where Rx filter module 71 bandpass filters inbound RF signal 88. The Rx filter module 71 provides the filtered RF signal to low noise amplifier 72, which amplifies inbound RF signal 88 to produce an amplified inbound RF signal. Low noise amplifier 72 provides the amplified inbound RF signal to down-conversion module 70, which directly converts the amplified inbound RF signal into an inbound low IF signal or baseband signal based on a receiver local oscillation 81 provided by local oscillation module 74. Down-conversion module 70 provides the inbound low IF signal or baseband signal to filtering/gain module 68. Filtering/gain module 68 may be implemented in accordance with the teachings of the present invention to filter and/or attenuate the inbound low IF signal or the inbound baseband signal to produce a filtered inbound signal.

Analog-to-digital converter 66 converts the filtered inbound signal from the analog domain to the digital domain to produce digital reception formatted data 90. Digital receiver processing module 64 decodes, descrambles, demaps, and/or demodulates digital reception formatted data 90 to recapture inbound data 92 in accordance with the particular wireless communication standard being implemented by radio 60. Host interface 62 provides the recaptured inbound data 92 to the wireless communication host device 18-32 via radio interface 54.

As one of average skill in the art will appreciate, the wireless communication device of FIG. 2 may be implemented using one or more integrated circuits. For example, the host device may be implemented on a first integrated circuit, while digital receiver processing module 64, digital transmitter processing module 76 and memory 75 may be implemented on a second integrated circuit, and the remaining components of radio 60, less antenna 86, may be implemented on a third integrated circuit. As an alternate example, radio 60 may be implemented on a single integrated circuit. As yet another example, processing module 50 of the host device and digital receiver processing module 64 and digital transmitter processing module 76 may be a common processing device implemented on a single integrated circuit.

Memory 52 and memory 75 may be implemented on a single integrated circuit and/or on the same integrated circuit as the common processing modules of processing module 50, digital receiver processing module 64, and digital transmitter processing module 76. As will be described, it is important that accurate oscillation signals are provided to mixers and conversion modules. A source of oscillation error is noise coupled into oscillation circuitry Is through integrated circuitry biasing circuitry. One embodiment of the present invention reduces the noise by providing a selectable pole low pass filter in current mirror devices formed within the one or more integrated circuits.

Local oscillation module 74 includes circuitry for adjusting an output frequency of a local oscillation signal provided therefrom. Local oscillation module 74 receives a frequency correction input that it uses to adjust an output local oscillation signal to produce a frequency corrected local oscillation signal output. While local oscillation module 74, up-conversion module 82 and down-conversion module 70 are implemented to perform direct conversion between baseband and RF, it is understood that the principles herein may also be applied readily to systems that implement an intermediate frequency conversion step at a low intermediate frequency.

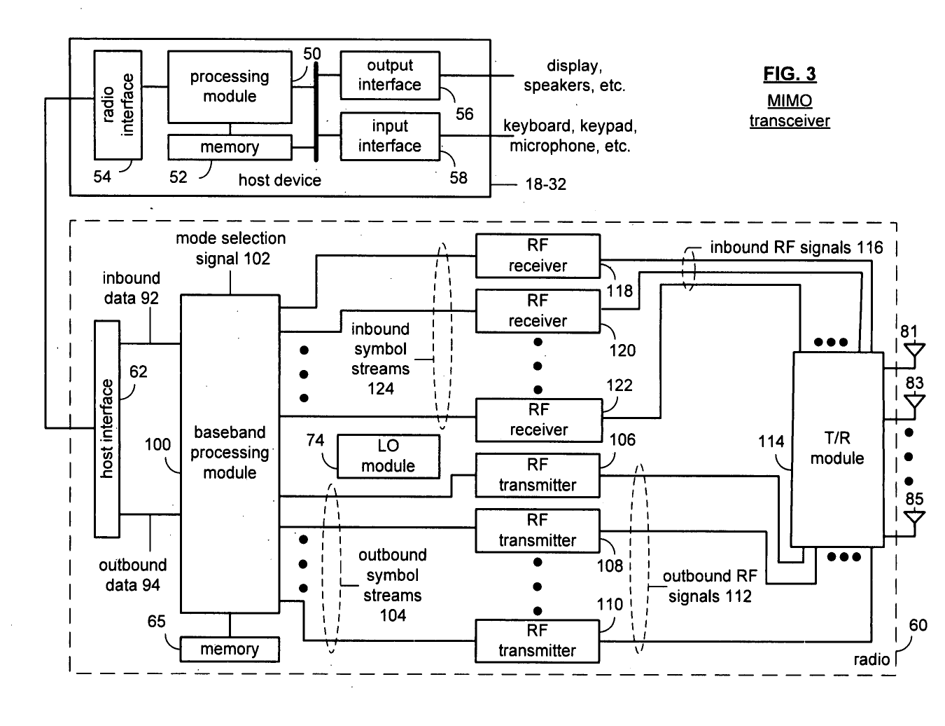

FIG. 3 is a schematic block diagram illustrating a wireless communication device that includes the host device 18-32 and an associated radio 60. For cellular telephone hosts, the radio 60 is a built-in component. For personal digital assistants hosts, laptop hosts, and/or personal computer hosts, the radio 60 may be built-in or an externally coupled component.

As illustrated, the host device 18-32 includes a processing module 50, memory 52, radio interface 54, input interface 58 and output interface 56. The processing module 50 and memory 52 execute the corresponding instructions that are typically done by the host device. For example, for a cellular telephone host device, the processing module 50 performs the corresponding communication functions in accordance with a particular cellular telephone standard.

The radio interface 54 allows data to be received from and sent to the radio 60. For data received from the radio 60 (e.g., inbound data), the radio interface 54 provides the data to the processing module 50 for further processing and/or routing to the output interface 56. The output interface 56 provides connectivity to an output display device such as a display, monitor, speakers, etc., such that the received data may be displayed. The radio interface 54 also provides data from the processing module 50 to the radio 60. The processing module 50 may receive the outbound data from an input device such as a keyboard, keypad, microphone, etc., via the input interface 58 or generate the data itself. For data received via the input interface 58, the processing module 50 may perform a corresponding host function on the data and/or route it to the radio 60 via the radio interface 54.

Radio 60 includes a host interface 62, a baseband processing module 100, memory 65, a plurality of radio frequency (RF) transmitters 106-110, a transmit/receive (T/R) module 114, a plurality of antennas 81-85, a plurality of RF receivers 118-120, and a local oscillation module 74. The baseband processing module 100, in combination with operational instructions stored in memory 65, executes digital receiver functions and digital transmitter functions, respectively. The digital receiver functions include, but are not limited to, digital intermediate frequency to baseband conversion, demodulation, constellation demapping, decoding, de-interleaving, fast Fourier transform, cyclic prefix removal, space and time decoding, and/or descrambling. The digital transmitter functions include, but are not limited to, scrambling, encoding, interleaving, constellation mapping, modulation, inverse fast Fourier transform, cyclic prefix addition, space and time encoding, and digital baseband to IF conversion. The baseband processing module 100 may be implemented using one or more processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory 65 may be a single memory device or a plurality of memory devices. Such a memory device may be a read-only memory, random access memory, volatile memory, non-volatile memory, static memory, dynamic memory, flash memory, and/or any device that stores digital information. Note that when the baseband processing module 100 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

In operation, the radio 60 receives outbound data 94 from the host device via the host interface 62. The baseband processing module 100 receives the outbound data 94 and, based on a mode selection signal 102, produces one or more outbound symbol streams 104. The mode selection signal 102 will indicate a particular mode of operation that is compliant with one or more specific modes of the various IEEE 802.11 standards. For example, the mode selection signal 102 may indicate a frequency band of 2.4 GHz, a channel bandwidth of 20 or 22 MHz and a maximum bit rate of 54 megabits-per-second. In this general category, the mode selection signal will further indicate a particular rate ranging from 1 megabit-per-second to 54 megabits-per-second. In addition, the mode selection signal will indicate a particular type of modulation, which includes, but is not limited to, Barker Code Modulation, BPSK, QPSK, CCK, 16 QAM and/or 64 QAM. The mode selection signal 102 may also include a code rate, a number of coded bits per subcarrier (NBPSC), coded bits per OFDM symbol (NCBPS), and/or data bits per OFDM symbol (NDBPS). The mode selection signal 102 may also indicate a particular channelization for the corresponding mode that provides a channel number and corresponding center frequency. The mode selection signal 102 may further indicate a power spectral density mask value and a number of antennas to be initially used for a MIMO communication.

The baseband processing module 100, based on the mode selection signal 102 produces one or more outbound symbol streams 104 from the outbound data 94. For example, if the mode selection signal 102 indicates that a single transmit antenna is being utilized for the particular mode that has been selected, the baseband processing module 100 will produce a single outbound symbol stream 104. Alternatively, if the mode selection signal 102 indicates 2, 3 or 4 antennas, the baseband processing module 100 will produce 2, 3 or 4 outbound symbol streams 104 from the outbound data 94.

Depending on the number of outbound symbol streams 104 produced by the baseband processing module 100, a corresponding number of the RF transmitters 106-110 will be enabled to convert the outbound symbol streams 104 into outbound RF signals 112. In general, each of the RF transmitters 106-110 includes a digital filter and upsampling module, a digital-to-analog conversion module, an analog filter module, a frequency up conversion module, a power amplifier, and a radio frequency bandpass filter. The RF transmitters 106-110 provide the outbound RF signals 112 to the transmit/receive module 114, which provides each outbound RF signal to a corresponding antenna 81-85.

When the radio 60 is in the receive mode, the transmit/receive module 114 receives one or more inbound RF signals 116 via the antennas 81-85 and provides them to one or more RF receivers 118-122. The RF receiver 118-122 converts the inbound RF signals 116 into a corresponding number of inbound symbol streams 124. The number of inbound symbol streams 124 will correspond to the particular mode in which the data was received. The baseband processing module 100 converts the inbound symbol streams 124 into inbound data 92, which is provided to the host device 18-32 via the host interface 62.

As one of average skill in the art will appreciate, the wireless communication device of FIG. 3 may be implemented using one or more integrated circuits. For example, the host device may be implemented on a first integrated circuit, the baseband processing module 100 and memory 65 may be implemented on a second integrated circuit, and the remaining components of the radio 60, less the antennas 81-85, may be implemented on a third integrated circuit. As an alternate example, the radio 60 may be implemented on a single integrated circuit. As yet another example, the processing module 50 of the host device and the baseband processing module 100 may be a common processing device implemented on a single integrated circuit. Further, the memory 52 and memory 65 may be implemented on a single integrated circuit and/or on the same integrated circuit as the common processing modules of processing module 50 and the baseband processing module 100.

Interleaving and de-interleaving according to the various embodiments of the invention is performed, within the embodiments of FIGS. 2 and 3, by the transmitter and receiver processing modules 76 and 64, respectively, of FIG. 2 and by the baseband processing module 100 of FIG. 3. Generally, though, any logic or circuitry that performs interleaving for transmissions and de-interleaving for receiver operations may implement any of the described embodiments of the invention.

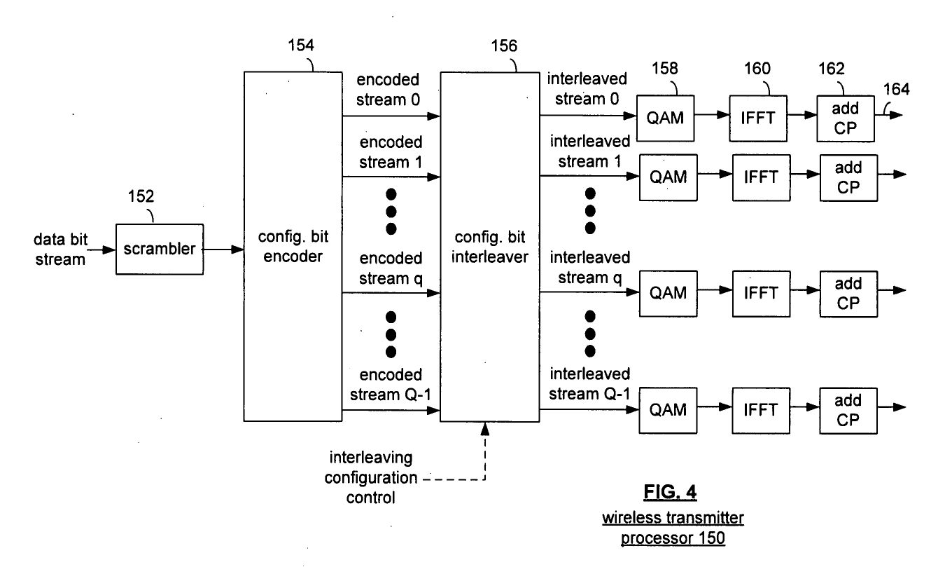

FIG. 4 is a functional block diagram of a wireless orthogonal frequency division multiplex (OFDM) transmitter processor that includes a multi-stream bit interleaver according to one embodiment of the invention. Referring to processor 150 of FIG. 4, a data bit stream is produced to a scrambler 152 where the bits are scrambled according to a specified technique. Scrambler 152 then produces scrambled bits to a configurable bit encoder 154 that encodes the scrambled bits and produces a specified number of encoded data streams. As is known by one of average skill in the art, encoders provide protection for bits to allow a bit stream portion to be reconstructed by a receiver if interference destroyed some of the bits in the transmission path. Here, encoder 154 produces encoded bits streams 0, 1, . . . q, . . . Q−1. Generally, the number of encoded bit streams is a function of the OFDM transmitter and a transmission mode of operation (transmission scheme). Accordingly, encoder 154 produces Q−1 encoded streams to interleaver 156. Interleaver 156, however, produces N−1 interleaved bit streams. The N−1 interleaved bit streams produced by interleaver 156 are interleaved according to the various embodiments of the invention as described herein. The number of streams N−1 produced by interleaver 156 is based upon a received control signal in one embodiment of the invention. Here, in FIG. 4, an interleaving control signal includes an indication of the number of output streams that are produced by interleaver 156.

Thus, each of the N−1 interleaved bit streams produced by interleaver 156 are processed through traditional processor logic blocks in preparation for transmission from a radio front end (not shown in FIG. 4). For example, interleaved bit stream 0 is produced to constellation encoding block 158 which performs specified quadrature amplitude modulation. Any known type of quadrature amplitude modulation may be used. In one embodiment, a traditional QPSK modulation is used. In another embodiment, 16-QAM modulation is used. Other types include, but are not limited to binary phase quadrature modulation (BPSK), 8-PSK, 64-QAM, 128-QAM, and 256-QAM. Constellation encoding is generally performed to increase data rates by generating data symbols that represent a plurality of bits.

Modulation block 158 then produces a modulation encoded signal to inverse Fast Fourier Transform (IFFT) block 160 which is operable to produce an inverse Fast Fourier Transform (IFFT) of the modulation encoded signal 160 to cyclic prefix block 162 which is operable to produce a guard interval for the signal prior to transmission from a radio front end.

The output of the signal with the cyclic prefix is shown at 164. The output at 164 is then produced to the radio front end that filters, amplifies and upconverts the outgoing signal to radio frequency prior to radiation from an antenna. Operation of each of the remaining branches for processing and transmitting the remaining Q−1 bit streams is the same as described for interleaved bit stream 0.

One important aspect of the invention illustrated in FIG. 4 is that interleaver 156 is configurable to perform interleaving across the plurality of bit streams according the number of bit streams being generated for a multi-branch transmitter that is operable to transmit from a plurality of antennas using OFDM modulation. For example, merely because an MIMO transmitter having the circuitry to generate, for example, four OFDM outgoing signals, does not mean that the MIMO transmitter will always transmit over four streams at once. If, for example, a selected transmission mode requires transmission over only two streams, then N−1 is equal to two. Accordingly, bit interleaver 156 receives only two encoded bit streams from encoder 154 and produces only two interleaved bits streams. Significantly, however, bits of each of the two bit streams are interleaved between the two streams in addition to being interleaved amongst the bits of each individual stream. Thus, interleaver 156 is configurable to utilize and includes logic configure the interleaving over a specified number of bit streams according to an interleaving configuration control signal. Generally, configurable bit encoder 154 is operable to produce Q−1 encoded streams to configurable bit interleaver 156. Interleaver 156 is operable to produce N−1 interleaved streams. Thus, the number of interleaved bit streams is based upon a specified value and not necessarily upon the number of encoded streams that are received. This aspect of Interleaver 156 may apply to all embodiments of the invention and is not limited to the embodiment of FIG. 4.

In the described embodiment of the invention, the number of encoded streams received is not necessarily equal to the number of interleaved streams that are produced by configurable bit interleaver 156. Further, the number of input and/or output streams may readily be modified based upon modes of transmission.

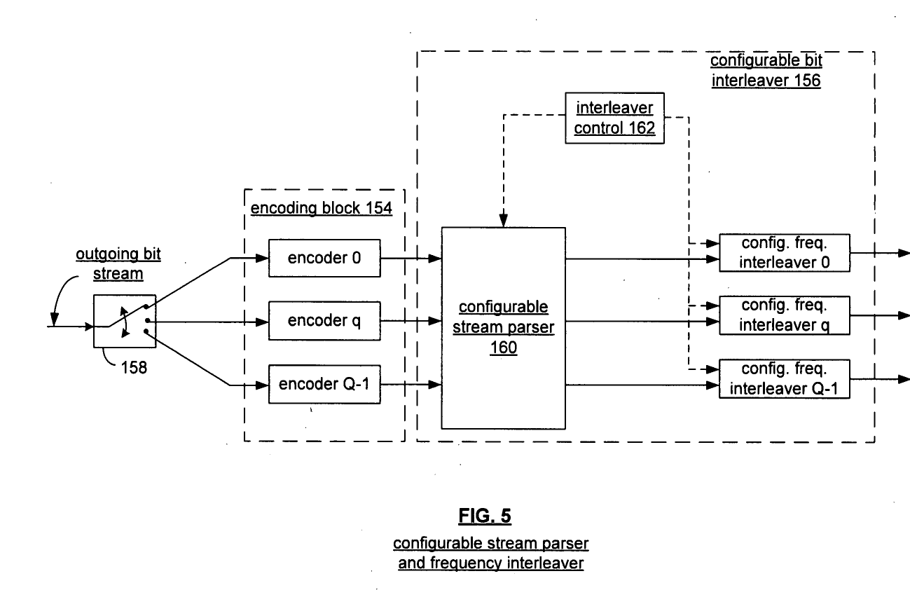

FIG. 5 is a functional block diagram of a configurable stream parser and frequency interleaver according to an embodiment of the invention. Generally, a configurable stream parser in combination with a plurality of configurable frequency interleavers that are operably coupled to a common controller collectively produce a flexible and configurable interleaver system operable to interleave signals across one or more output antennas in an OFDM transmitter according to a transmission mode of operation.

Specifically, an outgoing bit stream is received by a switching block 158 that is operable to distribute the outgoing bit stream. In the example of FIG. 5, block 158 produces three streams to encoding block 154. It should be understood, however, that block 158 is generally operable to produce a number of streams that correspond to a corresponding number of encoders used within encoding block 154 for a particular transmission mode. In one embodiment, block 158 is configurable to alter the number of outgoing streams according to a transmission mode. This embodiment is especially useful for an OFDM transmitter that may transmit from less than all of the outgoing signal paths.

Encoding block 154 produces a plurality of encoded bit streams to a configurable stream parser 160. Parser 160 is configurable to selectively alter the number of output streams produced according to a control command which is received from interleaver control 162. In one embodiment, parser 160 is operable to readily reconfigure itself to parse one or more input streams across two, three, four or more output streams based upon the control signal received from interleaver control 162.

Parser 160 produces parsed output streams to a corresponding plurality of configurable frequency interleavers of configurable bit interleaver 156. Operation of the configurable frequency interleavers according to the various embodiments of the invention will be described in greater detail below. Generally, however, each performs bit interleaving based upon a specified initial storage location and upon a specified initial extraction position (offset position) to achieve interleaving and frequency (block) rotation in one interleaving step.

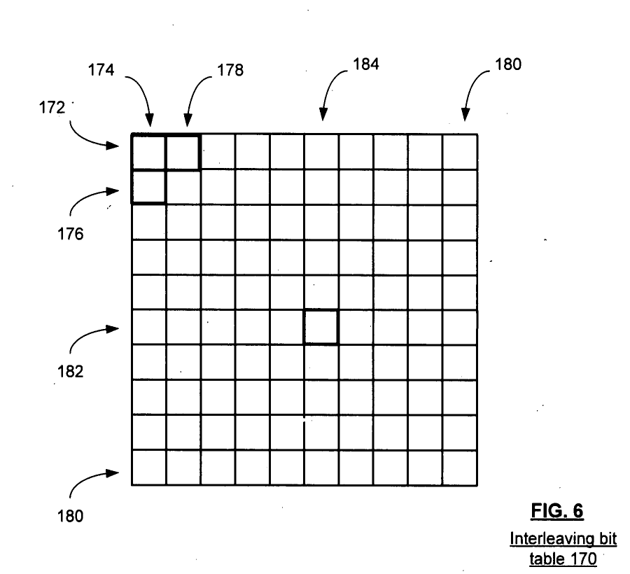

FIG. 6 is a table that illustrates a method for interleaving according to one embodiment of the invention. Generally, the method disclosed herein is a method according to one embodiment that is performed within each of the configurable frequency interleavers of configurable bit interleaver 156 of FIG. 5. Interleaving bit table 170 comprises a plurality of rows and tables used to temporarily hold bits of a bit stream that are to be interleaved. Interleaving is the permutation of the bit order and is used to minimize the effects of noise and transients upon a transmission signal. In effect, interleaving minimizes the number of bits that are lost of a specified byte or packet thereby facilitating the reconstruction and determination of the value of lost bits through known error correction techniques. Thus, bits in the order of 1 2 3 4 5 may be rearranged in the order of 3 5 1 2 4 at the transmission end and then rearranged from 3 5 1 2 4 back to 1 2 3 4 5 at the receiving end. If, for example, a noise transient that eliminates two bits in the center would result in, for example, bits 5 and 1 being eliminated instead of bits 2 and 3. Thus, because non-adjacent bits of the original stream are eliminated instead of adjacent bits, error correction techniques may more readily determine the values of bits 1 and 5.

In a MIMO context in which a plurality of transmissions may occur, it is advantageous to perform interleaving amongst a plurality of spatial streams as well as subcarriers to provide space diversity in addition to frequency diversity for a given bit stream to further eliminate the effects of interference. Thus, when an interleaver operating according to an embodiment of the present invention receives one or more bit streams, the bits are fed into a table as shown in an exemplary manner here in FIG. 6. In one embodiment, a first received bit is stored in the position defined by row 172 and column 174 (top left most corner of the table). A subsequent bit is then stored in row 172, column 178. In a similar manner, each subsequent bit is stored in an adjacent column but in the same row until a row is completely filled. Thereafter, a subsequent bit would be stored in row 176, column 174. More specifically, after a bit is stored in row 172, column 180, a subsequent bit is stored in row 176, column 174.

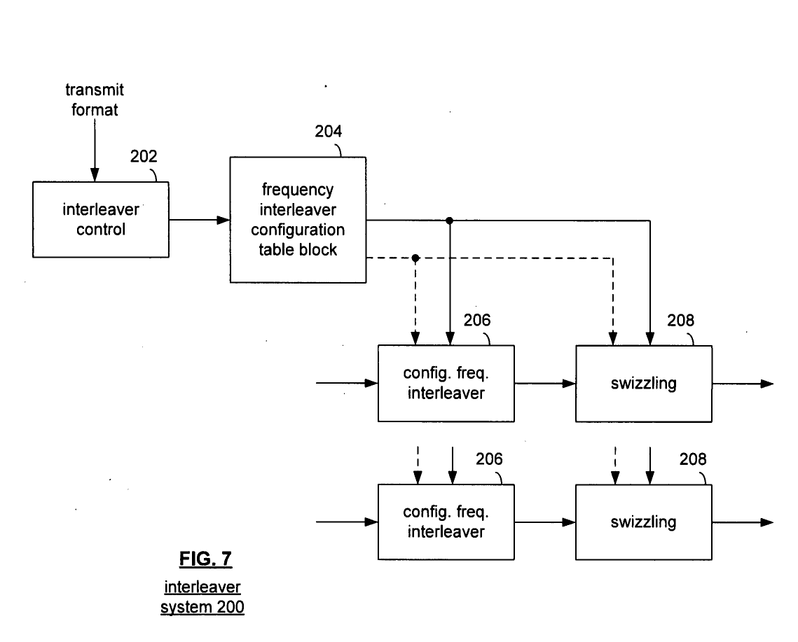

Thus, bits of a bit stream are stored first by row and then by column in this embodiment. They may, just as easily, be stored first by column and then by row. Traditionally, to produce an interleaved output, bits are read out in an opposite manner. Thus, starting at the same location into which the first bit was stored, bits are read out by column and then by row (if stored by row and then by column). In an alternate embodiment in which the bits were stored first by column and then by row, the bits are read out first by row and then by column. At a receiving end, a similar table is reconstructed to generate the original bit stream in which the bits are de-interleaved. To further understand interleaving according to the embodiments of the present invention, consider FIG. 7. In more general terms bits are stored in a first tabular order beginning at a first specified location and are extracted in a second tabular order beginning at an offset location (a second specified location different from the first specified location). In FIG. 6, such an offset location is shown at row 182, column 184.

FIG. 7 is a functional block diagram that illustrates an interleaver system 200 and control logic therefor according to one embodiment of the present invention. Interleaver system 200 includes an interleaver control logic 202 that is operably coupled to produce control signals to frequency interleaver configuration table block 204. Each of the configurable frequency interleavers and swizzling blocks, however, operate based upon frequency interleaver configuration tables and control signals received from the frequency interleaver configuration table block 204. What table is produced by frequency interleaver configuration table block 204 is based upon a control signal received from interleaver control block 202.

Interleaver control block 202 produces a control signal to frequency interleaver configuration table block 204 based upon a transmission format signal specified by a received signal that specified a current transmission format. Generally, especially in an OFDM compatible transmitter, the transmission format may vary from transmission from a single antenna to transmission on a plurality of antennas to increase transmission rates. Accordingly, interleaver control 202 specifies what configuration tables are to be produced to the configurable frequency interleavers 206 and swizzling blocks 208 based upon transmission mode. For example, if transmission is from a single antenna of a signal stream, interleaving will be performed only upon bits of one stream.

As such, an appropriate frequency interleaver configuration table is provided to at least one of the configurable bit interleaver blocks and the swizzling blocks of FIG. 7. Alternatively, if a plurality of transmit streams are to be used for transmitting, frequency interleaver configuration table block 204 will provide the corresponding control tables to at least a corresponding plurality the configurable frequency interleavers 206 and swizzling blocks 208. Swizzling blocks 208 are operable to cyclicly rotate the frequency interleaved bits received from the configurable frequency interleavers 206. The swizzling phase (amount of swizzling or cyclic rotation) may be based upon a current column of the interleaving table or upon a specified starting phase value that is incremented upon changes in the column of the interleaving table. The starting value may be a permanently specified value or may be specified in a control signal by logic.

Finally, each configurable frequency interleaver 206 of configurable bit interleaver block 156 and each swizzling block 208 is operably disposed to receive a control signal from frequency interleaver configuration table block 204 as well as configuration parameters for each stream. As such, according to a transmission mode of operation, the configurable frequency interleavers and swizzling blocks are flexible and can readily be adapted to interleave and swizzle bits according to a transmission mode of operation.

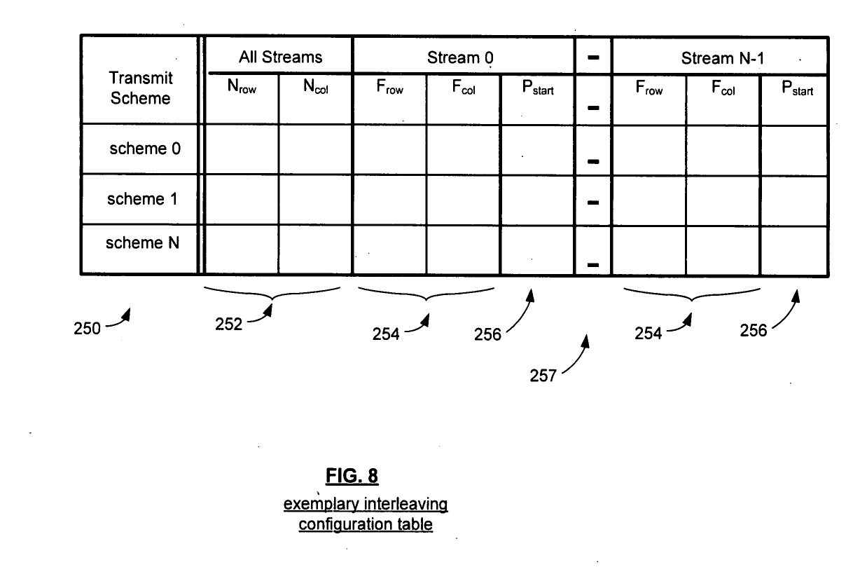

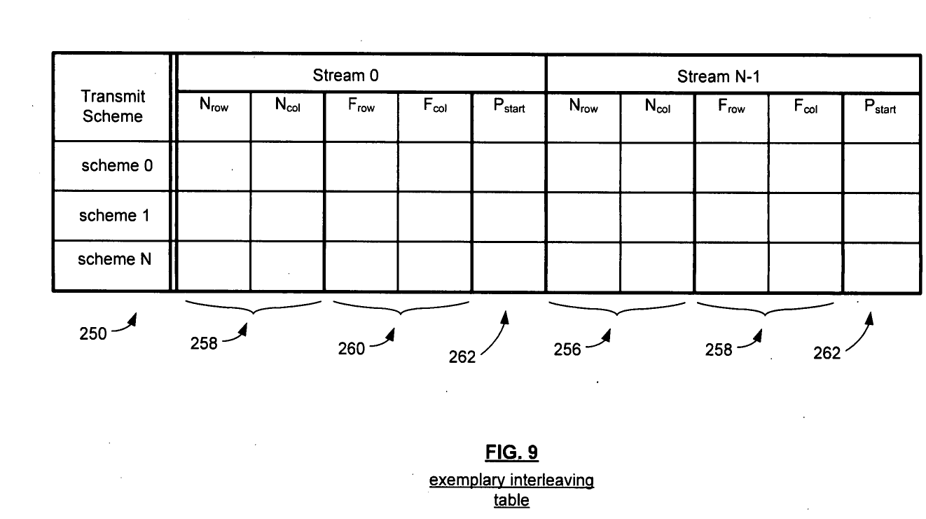

FIGS. 8 and 9 are interleaving configuration tables that illustrate two methods according to various embodiments of the present invention for performing row/column offset interleaving for a single or an OFDM transmission scheme. Referring to FIG. 8, a leftmost column 250 is used to identify a transmission scheme. For example, each transmission scheme of an OFDM transmitter specifies whether the transmitter transmits from only one antenna, two antennas, or, for example, four antennas. For each combination of possible transmit antennas, a transmission scheme is defined therefor.

For each scheme, therefore, interleaving parameters are specified within the table. In the specific embodiment of FIG. 8, the starting location for storing bit in an interleaving table is specified for all bit streams regardless of a transmission scheme. For example, in the prior art, the first bit of a stream is always stored in the upper leftmost corner. As such, there is no need to specify a starting coordinate for the storing of such bits. Similarly, in the prior art, the first bit that is extracted or read is from that same location. Accordingly, there is no need to specify a starting point for extracting or reading data bits. Here however, the interleaving scheme is more flexible in thus its starting location which is to be used for all streams for a given transmission scheme may be specified in columns shown generally at 252.

Additionally, for each stream of a transmission scheme, a starting location for reading (extracting) the bits from the interleaving table may be specified. Thus, for a transmit scheme that has two data streams, the table of FIG. 8 allows for a starting location to be specified for both of the streams for storing bits within the interleaving table but a separate location may be specified for each of the two streams for extracting the bits. Stated differently, each stream is allowed to have its own offset value for extracting or reading the bits. The coordinates of the offset location for reading the bits and the starting phase for each stream in relation to a give transmission scheme is generally at 254.

Each stream, in one embodiment of the invention, has a specified starting swizzling phase value as shown in column 256 labeled Pₛₜₐᵣₜ. A table such as that shown in FIG. 8 includes, in the columns shown generally at 254 which specify the starting location for reading bits, a column 256 for specifying Pₛₜₐᵣₜ. This column 254 is included only for those embodiments of the invention that include the particular aspect of specifying a starting swizzling phase (as opposed to the phase always having a defined starting value such as “0” wherein the phase is purely a function of the column of the interleaver table). Finally, a column 257 is shown containing a dash to indicate “n” streams and to reflect that the number of streams for which the table of FIG. 8 is used is not limited to two streams.

FIG. 9 is an exemplary interleaving configuration table that illustrates an alternate embodiment of the invention for storing bits into and for reading bits from an interleaving table. Referring now to FIG. 9, it may be seen that each stream includes a pair of columns shown generally at 258 for defining a value for a starting location to store bits into the interleaving table as well as a pair of columns shown generally at 260 that define a starting location to read or extract bits from interleaving table. Additionally, a column 262 is shown for defining a phase operator (starting swizzling phase value). Accordingly, all parameters specified for storing and extracting bits from the interleaving table are selectable and may be specified. Thus, each stream may have different values that are specified for each stream of each scheme. It should also be pointed out, for the embodiments of FIGS. 8 and 9, that the specification of a starting phase value is only for those embodiments in which such a phase value may be specified. For those embodiments in which the starting phase is merely a defined value, such a phase value would not be provided within the tables of FIGS. 8 and 9 and would either be a constant starting phase value or would be a function of the selected starting column or row (alternatively).

One additional aspect of FIGS. 8 and 9 includes specifying a row size of the row/column interleaver. Because of the configurable nature of the embodiments of the present invention, there is a need for an interleaver to know a row size because row sizes can be a function of the modulation scheme and the transmission scheme (SISO, MIMO, etc.). As such, one aspect of the invention includes specifying the row size in multiples of QAM symbols. As such, the row size is computer using the formula
Nrow=Nrow(QAM symbol)*specified multiple of QAM symbol.

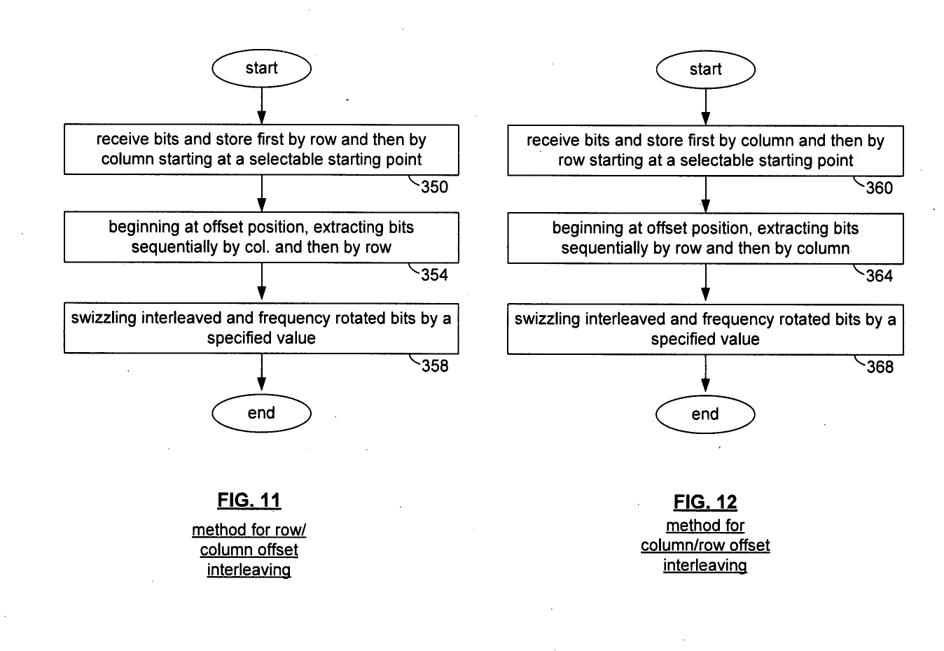

As with FIG. 8, the table of FIG. 11B may be used for any number of streams.

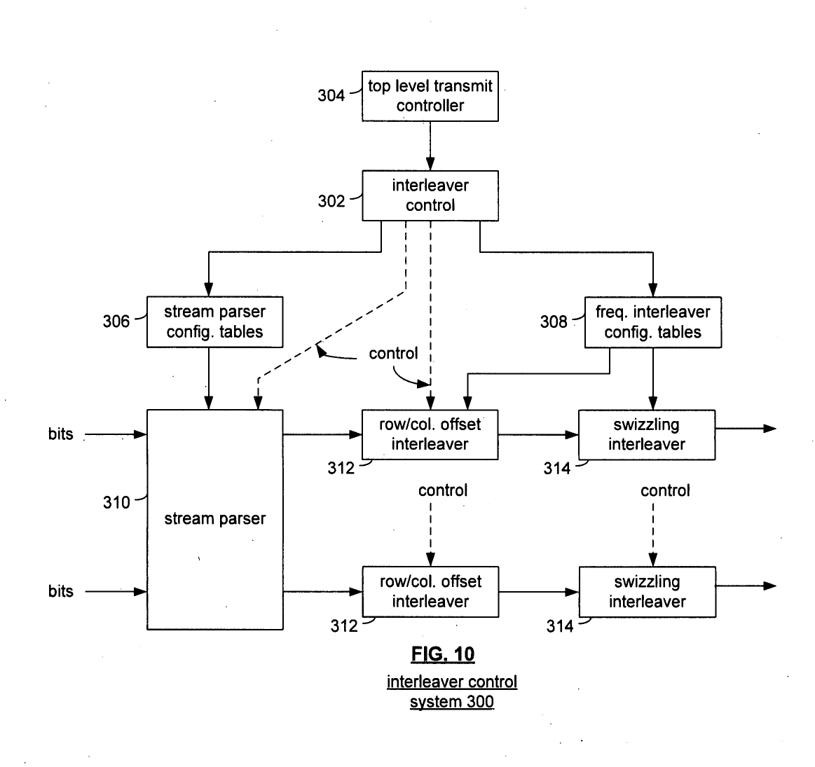

FIG. 10 is a functional block diagram of an interleaver control system according to one embodiment of the invention. As may be seen, an interleaver control system 300 includes an interleaver control block 302 that is operable to provide control signals as well as configuration signals for specifying a specified interleaving scheme based on a transmission scheme. As such, interleaver control block 302 bases its control and configuration signaling upon a received transmit mode which is received from a top level transmit controller or other logic.

In the described embodiment, the transmit mode identification is received from a top level transmit controller 304. For example, transmit controller 304 may comprise logic within transmitter processor. Interleaver control block 302 generates configuration information that is transmitted to a stream parser configuration tables block 306. Interleaver control block 302 also generates configuration information that is transmitted to frequency interleaver configuration tables 308. Stream processor configuration tables block 306 then generates appropriate configuration tables to a stream parser 310. The configuration tables generated by block 306 generally determine how may input streams are processed and how many output streams are produced.

In the example shown of FIG. 10, two streams are received and two are produced. It is understood, however, that these may readily vary and only two are shown for simplicity. Stream parser 310 is operably disposed to receive a single stream or a plurality of streams of bits for parsing. Stream parser performs such parsing based upon tables received from stream parser configuration tables block 306 and upon receiving a control signal from interleaver control block 302.

Similarly, frequency interleaver configuration tables block 308 produces configuration information to both a row/column offset interleaver 312 as well as to a swizzling interleaver 314. Row/column offset interleaver 312 performs its interleaving based upon the configuration information received from frequency interleaver configuration tables block 308 and upon a control signal received from interleaver control block 302. The interleaved output of low/column offset interleaver 312 is then produced to swizzling interleaver 314 that performs swizzling upon the interleaved data received from interleaver 312 based upon configuration information received from the frequency interleaver configuration tables block 308. For modes of operation in which stream parser 310 produces a plurality of output streams, a plurality of interleaving and swizzling blocks are utilized, one per stream, to perform the interleaving and swizzling.

FIG. 11 is a flow chart that illustrates a method for interleaving according to one embodiment of the invention. Initially, received bits are stored into an interleaving table by row and then by column at a selectable starting point (step 350). Thereafter, beginning at a selectable offset position, extracting bits sequentially by column and then by row (step 354). The extracted bits, which are interleaved and frequency rotated, are swizzled (cyclicly rotated) a specified number of times for a specified group size (step 358).

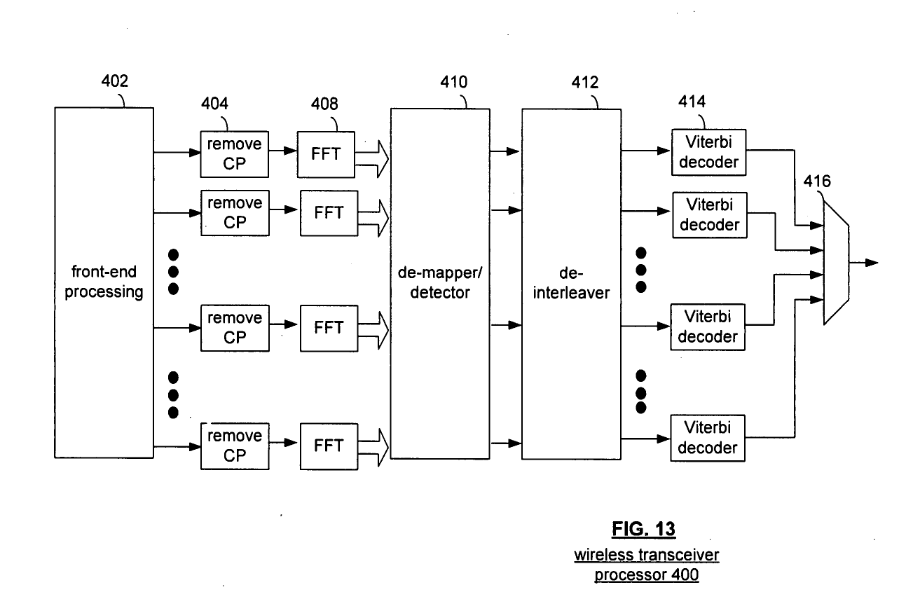

FIG. 12 is a flow chart that illustrates a method for interleaving according to one embodiment of the invention. Initially, received bits are stored into an interleaving table by column and then by row at a selectable starting point (step 360). Thereafter, beginning at a selectable offset position, the bits are extracted (read) sequentially by row and then by column (step 364). The extracted bits, which are interleaved and frequency rotated, are swizzled (cyclicly rotated) a specified number of times for a specified group size (step 368). This embodiment further includes starting the swizzling phase (number of times the bits are rotated) at a selectable and specified value.

For both methods described in relation to FIGS. 11 and 12, it is understood that the method steps may readily be combined with any and all other processes described herein including the parsing which is dependent upon a transmit mode or scheme. Further, the methods of FIGS. 11 and 12 may also be combined with flexible interleaving schemes that are also transmit mode dependent. Finally, while the methods of FIGS. 11 and 12 included complete flexibility, in that starting positions for storing bits, offset positions in the table may be selectable and specified by logic, swizzling phase may be selectable and specified by logic, other embodiments have less flexibility. For example, in one embodiment, the starting position is not selectable by logic and is always the same specified position. In another embodiment, the offset position in the table is not selectable and remains constant. In yet another embodiment, the starting swizzling phase is always a specified value (e.g., 0 meaning there is no rotation initially).

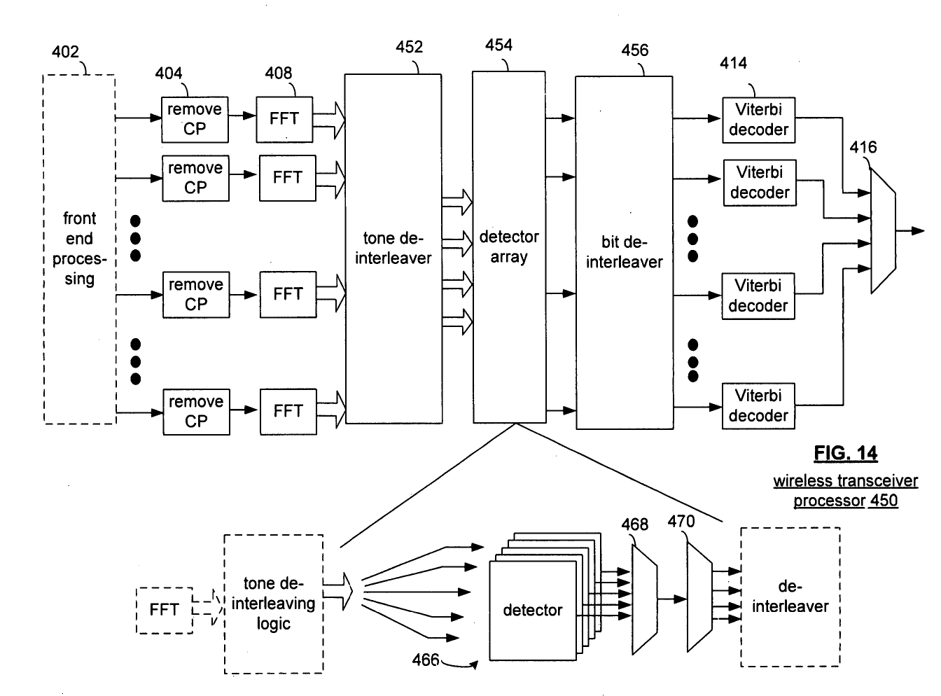

FIG. 13 is a functional block diagram of a wireless transceiver processor 400 for receiving and processing ingoing communication signals according to one embodiment of the invention. A front end processing block 402 is operable to receive an ingoing RF communication signal, for example, an OFDM signal, over a plurality of antennas and to produce a plurality of ingoing signal streams. The plurality of ingoing signal streams are then each produced to logic 404 for removing a cyclic prefix (guard band). The ingoing streams are then produced to Fast Fourier Transform (FFT) logic 408 for converting the ingoing streams to a plurality of tones to convert the ingoing streams from a time domain signal to a frequency domain signal. Logic 404 and 408 for removing the cyclic prefix and for generating tones are known by those of average skill in the art. Each FFT logic 408 is operable to produce a plurality of tones. In the described embodiment, 64 tones are produced by each FFT logic block 408.

A de-mapper/detector 410 then receives the tones from each FFT logic block 408 that is operable to equalize the ingoing frequency domain signals. In one embodiment, linear equalization is applied to the frequency domain signals. Alternatively, a maximum likelihood (ML) detector may be used, especially for MIMO applications subject to fading channels in the presence of additive white Gaussian noise. These types of detection approaches, however, are known by those of average skill in the art and may be chosen according to design requirements. Generally, though, a detector is included to recover soft bit information of a corresponding QAM symbol to produce an LLR (soft bit information) corresponding to the QAM symbol that was transmitted.

After detection by detector 410, each of the ingoing bit stream of soft bit information are produced to a de-interleaver 412 that is operable to de-interleave the ingoing signals in a manner that is compatible with interleaving techniques by the transmitter that generated the ingoing signal that is being received and processed. For example, the de-interleaver is operable to de-interleave a bit stream that was interleaved and swizzled, as described in relation to FIGS. 6 and 7, in a manner that compensates for the interleaving and swizzling steps to produce an original bit stream. Thereafter, the de-swizzled and de-interleaved bits streams are produced to Viterbi decoders 414 for error correction and, more generally, data detection. The outputs of the Viterbi decoders 414 are then produced to a multiplexer 416 that is operable to combine the decoded streams produced by the decoders 414 to recreate the original data stream.

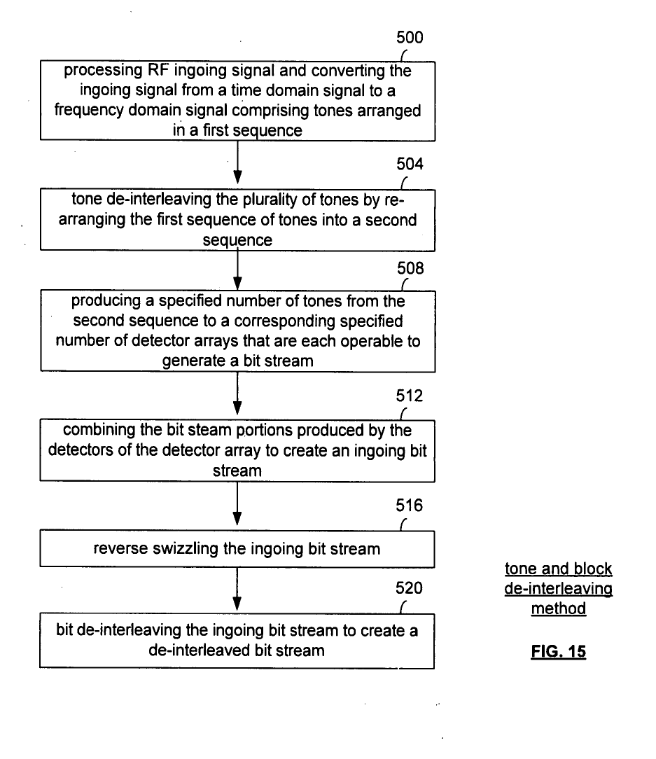

FIG. 14 is a functional block diagram of a wireless transceiver processor 450 according to one embodiment of the invention. Similar to the embodiment of FIG. 13, the processor 450 includes a front end processing block 402, logic 404, and logic 408 that operate as described before. The outputs of each FFT logic block 408 comprise 64 tones (in the described embodiment of the invention) that are produced to a tone de-interleaver 452. Each FFT logic block 408 produces the tones arranged initially in a first sequence. Thereafter, tone de-interleaver 452 is operable to re-arrange the tones from a first sequence to a second sequence wherein the second sequence corresponds to a sequential order the tones are expected to be received by the Viterbi decoders 414.

Tone de-interleaver 452 then produces a tone to each detector of a detector array 454. Each detector then produces a stream of soft bits representing a subcarrier of a tone. The streams of soft bits are then combined and produced to a bit de-interleaver 456 that is operable to de-swizzle and de-interleave the soft bit streams to produce de-interleaved bits to Viterbi decoder 414. The decoded output of each Viterbi decoder 414 is then combined to produce an original sequence of bits in comparison to an original stream of outgoing bits the transmitter.

The detector array 454 may be seen in more functional terms in the broken out section of FIG. 14. Tone de-interleaving logic within tone de-interleaver 452 produces a sequence of re-arranged tones, as described before, to detector array 454. Generally, a tone is produced to each detector of a group of detectors shown generally at 466. The output of each detector is then produced to a multiplexer 468 that is operable to combine the outputs to create a soft bit stream. The soft bit stream is then produced to a multiplexer-470 for fanning out to each input of de-interleaver 456. It is understood, of course, that use of the multiplexers adds some latency but decreases hardware requirements. Otherwise, for example, a group of detectors 466 would need to be provided for each of the signal streams.

In one embodiment of the invention, an approximate ratio of 1:6 exists for the number of detectors to tones that are to be processed using the described architecture. More specifically, eleven detectors are used for each set of 64 tones received from the FFT logic blocks. It should be understood that the numbers of detector blocks and tones produced by the FFT logic blocks are design parameters that may be varied. No additional latency is introduced from this arrangement because this arrangement results in processing that is faster than a down stream decoder (e.g., a Viterbi decoder) and thus satisfies overall requirements to process one symbol within a specified symbol processing time. In 802.11 for wireless LANs, for example, a four microsecond period is allocated to processing symbols.

One reason the structure and method of FIG. 14 reduces overall latency with a more hardware efficient circuit is that re-arranging the tones in the order the Viterbi decoders expect to see the soft bits generated from re-arranged tones enables the Viterbi detectors to begin processing the earliest tones first. Under other designs, an interleaved tone that was not first in time would consume processing time before a tone that needs to be sent to the Viterbi decoder first is processed. As such, the Viterbi decoding process does not begin until a first tone is “detected” by a detector. Thus, by rearranging the tones a priori, the Viterbi decoders are allowed to begin processing despite interleaving steps at the transmitted side of the communication.

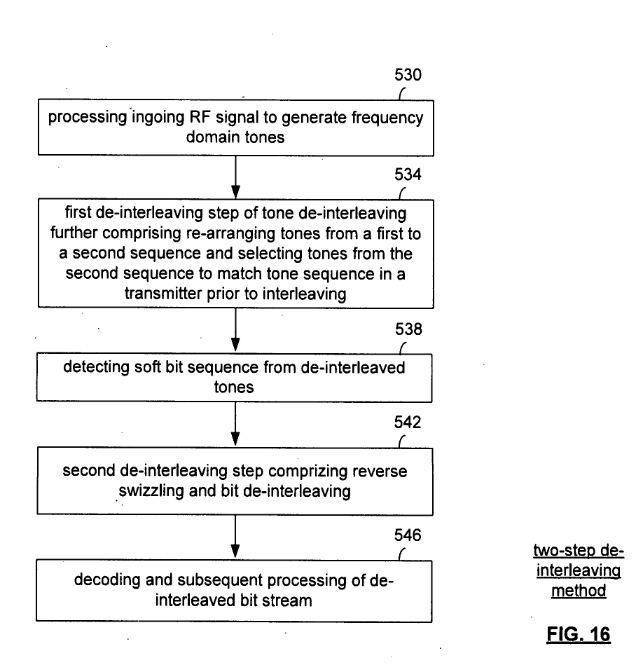

FIG. 15 is a flow chart illustrating a method for tone and bit de-interleaving according to one embodiment of the invention. Initially, the method includes processing an RF ingoing signal and converting the ingoing signal from a time domain signal to a frequency domain signal comprising tones arranged in a first sequence (step 500). With respect to a processor, such RF processing is typically performed externally by radio front end circuitry that is operable to down-convert received RF communication signals that are time domain based signals. Thereafter, the processor is operable to remove a guard band or cyclic prefix between signals and to convert the signals from the time domain to the frequency domain. All of this is part of step 500.

Subsequently, the method includes tone de-interleaving the plurality of tones by re-arranging the first sequence of tones into a second sequence to compensate for scrambling by transmitter prior to interleaving in one embodiment of the inventive interleaver (step 504). More significant, however, is that the tones are arranged in an order expected by down stream Viterbi decoders to reduce processing delays. Once the original sequence of tones are rearranged into a second sequence of tones, a specified number of tones are selected and distributed to a corresponding specified number of detectors of a detector array that are each operable to generate a bit stream (step 508). The number of tones that are selected correspond to the number of detectors of the detector array and vice-versa. After producing a specified number of tones from the second sequence to a corresponding specified number of detector arrays, the method includes combining the bit steam portions produced by the detectors of the detector array to create an ingoing bit stream corresponding to the tones in the sequential order of the tones after they were rearranged (the second sequential order) to create an ingoing bit stream (step 512).

After the bit stream has been created in the sequential order of the tones, the bits themselves for each tone still require de-swizzling and de-interleaving. Accordingly, the next step is to reverse swizzling the ingoing bit-stream to arrange the bits in an order that corresponds to an interleaved bit stream in the transmitter prior to swizzling (step 516). Finally, the method includes bit de-interleaving the ingoing bit stream to create a de-interleaved bit stream that ideally (for example, no effects from transmission interference) matches an outgoing bit stream in a transmitter prior to scrambling and interleaving by the transmitter that generated the received signal (step 520).

FIG. 16 is a flow chart that illustrates a two-step method for de-interleaving a received signal according to one embodiment of the invention. The method initially includes processing an ingoing RF signal to generate frequency domain tones (step 530). Thereafter, the method includes a first de-interleaving step of tone de-interleaving further comprising re-arranging tones from a first to second sequence and selecting tones from the second sequence to match tone sequence in a transmitter prior to interleaving (step 534).

Thereafter, the method includes detecting bit sequence from de-interleaved tones (step 538). The step of detecting the bit sequence generates a soft information sequence that is used to generate an error corrected bit sequence by down stream error correction circuitry. In the described embodiments, Viterbi decoders are utilized but other types of error correcting circuits may also be used. Thereafter, the method includes a second de-interleaving step comprising reverse swizzling and bit de-interleaving (step 542). Finally, the method concludes with error decoding and subsequent processing of a de-interleaved bit stream (step 546).

Each description of the figures herein is exemplary. It should be understood that the present embodiments of the invention relate to de-interleaving an interleaved signal in a manner that produces an output bit stream that matches an outgoing bit stream prior to interleaving. As such, the flexibility of the interleaver of the transmitter is matched in the de-interleaver of the receiver. For example, a similar control structure to that shown for FIG. is implemented in the receiver to result in a similar but reverse process. The de-interleaver, however, in addition to having similar circuitry of the interleaver to produce the original bit stream, further includes a topology and circuitry that more efficiently (cost effectively) de-interleaves the ingoing signal including circuitry for the two-step de-interleaving process. These aspects are emphasized herein since the circuitry for interleaving have been fully described in the related application which is incorporated herein in its entirety.

As one of ordinary skill in the art will appreciate, the term “substantially” or “approximately”, as may be used herein, provides an industry-accepted tolerance to its corresponding term and/or relativity between items. Such an industry-accepted tolerance ranges from less than one percent to twenty percent and corresponds to, but is not limited to, component values, integrated circuit process variations, temperature variations, rise and fall times, and/or thermal noise. Such relativity between items ranges from a difference of a few percent to magnitude differences. As one of ordinary skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled”.

While the invention is susceptible to various modifications and alternative forms, specific embodiments thereof have been shown by way of example in the drawings and detailed description. It should be understood, however, that the drawings and detailed description thereto are not intended to limit the invention to the particular form disclosed, but, on the contrary, the invention is to cover all modifications, equivalents and alternatives falling within the spirit and scope of the present invention as defined by the claims. As may be seen, the described embodiments may be modified in many different ways without departing from the scope or teachings of the invention.

1. A method for processing and de-interleaving a received signal, comprising:
receiving a continuous wave radio frequency signal and front end processing the radio frequency signal to filter, amplify and down-convert the radio frequency signal to produce a down-converted ingoing signal;
converting the ingoing signal from a time domain signal to a frequency domain signal wherein the frequency domain signal comprises a plurality of tones arranged in a first sequence;
tone de-interleaving the plurality of tones by re-arranging the first sequence of tones into a second sequence;
producing a specified number of tones from the second sequence to a corresponding specified number of detector arrays that are each operable to generate a bit stream portion therefrom; and
combining the bit steam portions produced by the detector array to create an ingoing bit stream;
bit de-interleaving the ingoing bit stream to create a de-interleaved bit stream that, without transmission interference, matches an outgoing bit stream in a transmitter prior to scrambling and interleaving by the transmitter that generated the received signal.

2. The method of claim 1 wherein the step of re-arranging the first sequence of tones into the second sequence of tones in the tone de-interleaving step compensates for scrambling performed by the transmitter.

3. The method of claim 1 wherein the step of bit de-interleaving the ingoing bit stream includes reverse swizzling the ingoing bit stream to produce a reverse-swizzled bit stream that corresponds to an interleaved bit stream in the transmitter prior to swizzling.

4. The method of claim 3 further comprising determining a starting swizzling phase value that, upon reverse swizzling, generates correctly de-swizzled bits and de-swizzling the bits.

5. The method of claim 4 further including cyclicly changing the swizzling phase value to compensate for changes in the transmitter swizzling phase values prompted by changes in either a column or row of interleaving table(s) of a transmitter interleaver.

6. The method of claim 3 wherein the step of de-interleaving the ingoing bit stream includes simultaneously reverse frequency rotating and reverse interleaving the reverse-swizzled bit stream.

7. The method of claim 6 wherein the step of simultaneously reverse frequency rotating and reverse interleaving the reverse-swizzled bit stream includes:
storing the reverse-swizzled bit stream in a table that corresponds in dimensions to an interleaving table used by the transmitter that transmitted the received signal;
sequentially extracting bits from the interleaving table starting at a specified offset location to generate the de-interleaved bit stream that corresponds to a bit sequence order in which bits were received for storing in the interleaving table of the transmitter.

8. The method of claim 5 further including Viterbi decoding the de-interleaved bit stream.

9. Circuitry for processing and de-interleaving a received signal, which received signal was scrambled and interleaved by a transmitter, comprising:
tone de-interleaving circuitry for receiving a first sequence of tones and for rearranging the first sequence of tones into a second sequence of tones, which rearranging to produce the second sequence of tones operably compensates for the scrambling performed by the transmitter and arranges the tones in an order expected by a downstream decoder;
logic for selecting a number of tones from the second sequence of tones for detection to generate a soft bit sequence;
a plurality of detector array circuits each operable to produce a bit sequence from a selected tone, wherein the number of the plurality of detector array circuits corresponds to the number of tones selected from the second sequence of tones wherein each of the plurality of detector array circuits receives one of the tones selected from the second sequence of tones; and
de-interleaving circuitry to de-interleave bit sequences produced by the number of the plurality of detector array circuits.

10. The circuitry of claim 9 wherein the de-interleaving circuitry further includes a plurality of block de-interleaving circuit paths that correspond to a number of interleaving circuit paths used by the transmitter.

11. The circuitry of claim 10 wherein each of the plurality of block de-interleaving circuit paths include reverse swizzling circuitry operable to swizzle a bit stream received from at least one detector array circuit in an order that compensates for swizzling of a swizzler of the transmitter wherein the reverse swizzling circuitry produces a reverse-swizzled bit stream.

12. The circuitry of claim 11 further including logic for creating a table in memory characterized by N rows and N columns, which table corresponds in dimensions to an interleaving table used by the transmitter that generated the received signal.

13. The circuitry of claim 12 further including logic for de-interleaving bits in the table by reverse interleaving and reverse frequency rotating the reverse-swizzled bit stream by sequentially extracting bits from the table in an order that generates bits in an order in which bits were stored in the interleaving table of the transmitter to produce a de-interleaved bit stream.

14. The circuitry of claim 9 wherein the logic that selects the tones from the second sequence of tones is operable to sequentially arrange the tones in an order expected by a down-stream Viterbi decoder.

15. Circuitry for processing and de-interleaving a received signal, comprising:
de-interleaving circuitry to de-interleave received bit sequences produced by a number of detector array circuits wherein the de-interleaving circuitry further includes a plurality of block de-interleaving circuit paths that correspond to a number of interleaving circuit paths used by a transmitter that generated the received signal; and
wherein the de-interleaving circuitry includes logic to generate a table that is sized the same as an interleaving table of interleaving circuitry of a transmitter and further wherein the de-interleaving circuitry begins to extract bits from the table from an offset location that corresponds to an offset location utilized within the transmitter to interleave the bits prior to transmission.

16. The circuitry of claim 15 further including logic for creating the table in memory characterized by N rows and N columns, which table corresponds in dimensions to the interleaving table used by the transmitter that generated the received signal.

17. The circuitry of claim 16 further including logic for de-interleaving bits in the table by reverse interleaving and reverse frequency rotating a reverse-swizzled bit stream by sequentially extracting bits from the table in an order that generates bits in an order in which bits were stored in the interleaving table of the transmitter to produce a de-interleaved bit stream.

18. The circuitry of claim 15 further including tone de-interleaving circuitry for receiving and processing a first sequence of tones.

19. The circuitry of claim 18 wherein the tone de-interleaving circuitry is operable to rearrange the first sequence of tones into a second sequence of tones, which second sequence of tones operably compensates for scrambling performed by the transmitter that generated the received signal prior to interleaving outgoing bits.

20. The circuitry of claim 19 further including logic for selecting a number of tones from the second sequence of tones.

21. The circuitry of claim 20 further including a number of detector array circuits each operable to produce a bit sequence from a tone, wherein the number of detector array circuits corresponds to the number of tones selected from the second sequence of tones wherein each of the detector array circuits receives one of the tones selected from the second sequence of tones.

22. The circuitry of claim 21 wherein each of the detector array circuits produces the bits sequences and are combined in a specified order that corresponds to a bit sequence produced by swizzling circuitry in the transmitter prior to transmission.

23. The circuitry of claim 22 wherein each de-interleaving circuit path includes reverse swizzling circuitry operable to swizzle the bit stream received from at least one detector array circuit in an order that compensates for swizzling of a swizzler of the transmitter wherein the reverse swizzling circuitry produces a reverse-swizzled bit stream.

24. The circuitry of claim 23 wherein the reverse-swizzled bit stream is produced to the de-interleaving circuitry to de-interleave the reverse-swizzled bit stream.
